(19) United States
(12) Patent Application Publication
(10) Pub. No.: US 2006/0259194 A1
(43) Pub. Date: Nov. 16, 2006

(54) Virtual wall system

(75) Inventor: Ting-Yin Chiu, Taichung City (TW)

Correspondence Address: BACON & THOMAS, PLLC, 625 SLATERS LANE, FOURTH FLOOR, ALEXANDRIA, VA, 22314, US

(73) Assignee: INFINITE ELECTRONICS INC., TAICHUNG CITY (TW)

(21) Appl. No.: 11/176,244

(22) Filed: Jul. 8, 2005

(30) Foreign Application Priority Data
May 9, 2005 (TW) 94114966

(51) Int. Cl. G06F 19/00

(52) U.S. Cl. 700/245

(57) ABSTRACT

A virtual wall system includes a mobile robotic device having a steering unit for steering itself, a steering control unit connected with the steering unit for controlling the steering of the steering unit, at least one signal transmitter mounted thereon for emitting a signal, and a sonic receiver for receiving a sonic signal; and a virtual wall generator having at least one signal receiver for receiving the signal, at least one sonic transmitter for emitting a sonic signal, and a signal controller for identifying the signal and controlling the emission of the sonic transmitter. While the mobile robotic device is moving, the signal controller controls the sonic transmitter to emit the sonic signal after the signal receiver receives the signal emitted by the signal transmitter and then the sonic receiver receives the sonic signal, enabling the steering control unit to control the steering unit to steer the mobile robotic device.

### BACKGROUND OF THE INVENTION

1. Field of the Invention

The present invention relates generally to control of a mobile robotic device, and more particularly, to a virtual wall system.

2. Description of the Related Art

A conventional mobile robotic device, like a mobile robot, a mobile carrier, or a mobile robotic vacuum cleaner, is based on a predetermined path or visual recognition for identification of the direction, speed, and distance of movement. For example, as disclosed in U.S. Patent Publication No. 2004/0,111,184, a mobile robotic vacuum cleaner enables a light beam to function as a virtual wall by its light transmitting unit thereof mounted on a predetermined position for emitting the light beam toward a predetermined direction and its light receiving unit provided for receiving the light beam. While moving to receive the light beam, the mobile robotic vacuum cleaner emits a signal of diversion to keep itself within a working area defined by the light beam to further effect the virtual wall.

However, while operated, the light transmitting unit must keep emitting the light beam to ensure the light receiving unit to receive the light beam while the mobile robotic vacuum cleaner passes by it, thus keeping consuming the power energy. If the power energy of the light transmitting unit is supplied by the battery, the consumption of the power energy will run fast. If the power energy of the light transmitting unit is supplied by the mains electricity, the user may forget to pull the plug to incur danger of burnout or the wire connected between the mains supply and the vacuum cleaner may interrupt the movement of the vacuum cleaner.

### SUMMARY OF THE INVENTION

The primary objective of the present invention is to provide a virtual wall system, which generates a virtual wall for altering movement activity of a mobile robotic device operating in a defined working area by a manner different from the prior art.

The secondary objective of the present invention is to provide a virtual wall system, which is more power saving than the prior art.

The foregoing objectives of the present invention are attained by the virtual wall system, which is composed of a mobile robotic device and at least one virtual wall system. The mobile robotic device includes a steering unit for steering itself toward at least one direction, a steering control unit connected with the steering unit for controlling the steering of the steering unit, at least one signal transmitter mounted thereon for emitting a signal, and a sonic receiver for receiving a sonic signal. The virtual wall generator includes at least one signal receiver for receiving the signal emitted by the signal transmitter, at least one sonic transmitter for emitting a sonic signal toward a predetermined direction, and a signal controller for identifying the signal received by the signal receiver and controlling the emission of the sonic transmitter. While the mobile robotic device is moving, the signal controller controls the sonic transmitter to emit the sonic signal after the signal receiver receives the signal emitted by the signal transmitter and then the sonic receiver receives the sonic signal, enabling the steering control unit to control the steering unit to steer the mobile robotic device.

### BRIEF DESCRIPTION OF THE DRAWINGS

FIG. 1 is a schematic view of a preferred embodiment of the present invention.

FIG. 2 shows the virtual wall generator of the preferred embodiment of the present invention.

FIG. 3 is a schematic view of the preferred embodiment of the present invention in action.

FIG. 4 is another schematic view of the preferred embodiment of the present invention in action.

FIG. 5 is an alternative view of the virtual wall generator.

FIG. 6 is another alternative view of the virtual wall generator.

FIG. 7 is another schematic view of the preferred embodiment of the present invention in action.

### DETAILED DESCRIPTION OF PREFERRED EMBODIMENTS

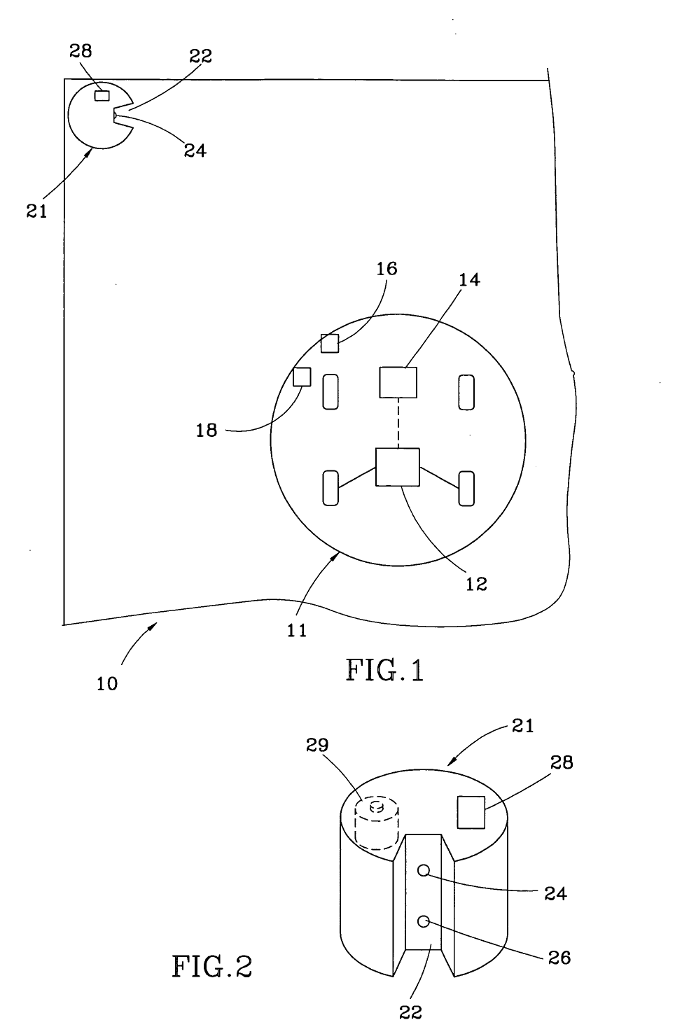

Referring to FIGS. 1 and 2, a virtual wall system 10 for control of a mobile robotic device is composed of a mobile robotic device 11 and a virtual wall system 21.

The mobile robotic device 11 includes a steering unit 12 for steering itself toward at least one direction, a steering control unit 14 connected with the steering unit 12 for controlling the steering of the steering unit 12, at least one signal transmitter 16 mounted on a side thereof for emitting a (light) signal towards a direction against the mobile robotic device 11, and a sonic receiver 18 provided for receiving a sonic signal.

The virtual wall generator 21 is mounted on a planar surface that the mobile robotic device 11 moves, like the ground, including at least one cavity 22, a signal receiver 24, a sonic transmitter 26, a signal controller 28, and a power module 29. The cavity 22 is taper-shaped to be defined between two sloped sidewalls and a bottom sidewall, having an opening facing sideward. The distance between the two sloped sidewalls of the cavity 22 is increasing from the bottom sidewall to the opening. The signal receiver 24 is mounted in the cavity 22 for receiving the signal emitted into the cavity 22 by the signal transmitter 16. The sonic transmitter 26 is mounted in the cavity 22 for emitting a sonic signal toward the opening of the cavity 22, wherein the sonic signal is an ultrasonic signal in this embodiment. The signal controller 28 is provided for identifying the signal received by the signal receiver 24 and controlling the emission the sonic transmitter 26. The power module 29, such as battery, is provided for supplying the mobile robotic device 11 with electricity.

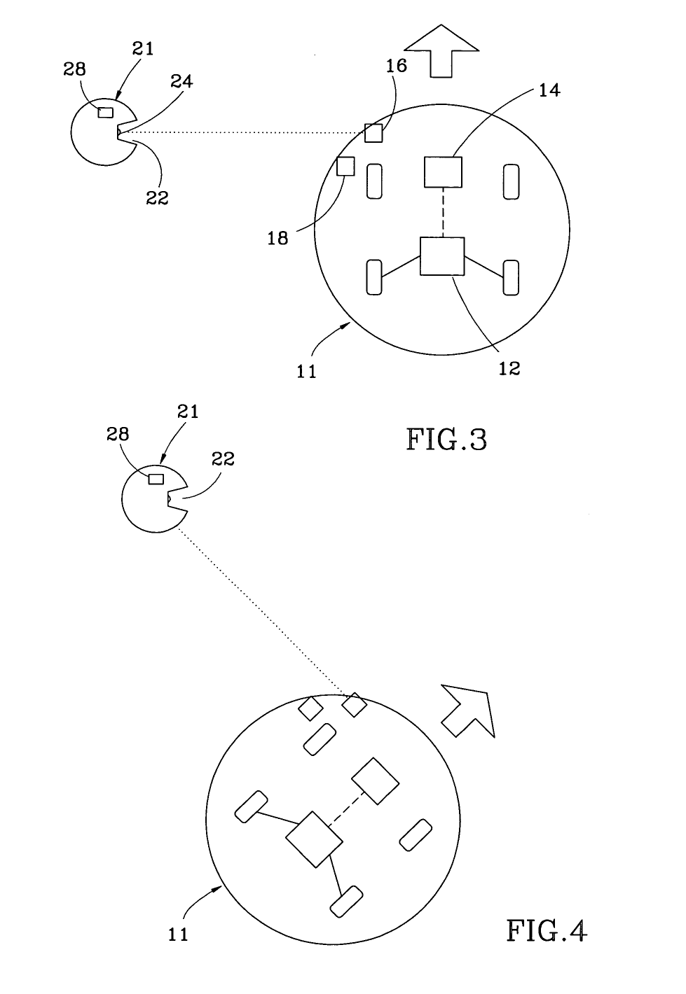

Referring to FIG. 2 and 3, while the mobile robotic device 11 is moving, after the signal receiver 24 receives the signal emitted from the signal transmitter 16, the signal controller 28 controls the sonic transmitter 26 to emit a sonic signal and then the sonic receiver 18 receives the sonic signal, enabling the steering control unit 14 to control the steering unit 12 to steer the mobile robotic device 11.

As shown in FIG. 3, the cavity 22 has a predetermined angle defined by the two sloped sidewalls. The signal receiver 24 receives the signal and the sonic transmitter 26 emits the sonic signal within the predetermined angle to enable the signal transmitter 16 and the sonic receiver 18 to be covered within the predetermined angle while the mobile robotic device 11 passes by the virtual wall generator 21. Referring to FIG. 4, while the mobile robotic device 11 passes by the virtual wall generator 21 and the signal transmitter 16 and the sonic receiver 18 are not covered within the predetermined angle of the cavity 22, the signal transmitter 16 fails to emit the signal into the cavity 22 and then the virtual wall generator 21 neither receives the signal from the mobile robotic device 11 nor emits the sonic signal to steer the mobile robotic device 11.

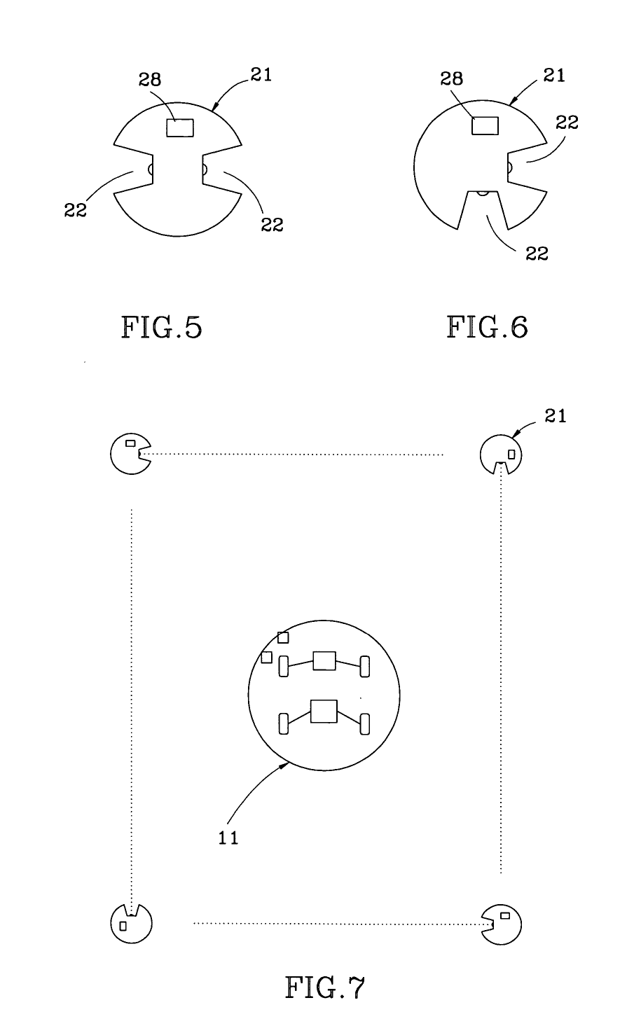

Referring to FIG. 5, the virtual wall generator 21 alternatively includes two cavities 22, which openings located back to back. Referring to FIG. 6, the openings of the two cavities 22 are alternatively located at the right angle. Further, the virtual wall system 10 alternatively includes four virtual wall generators 21 mounted at four corners around the mobile robotic device 11 for defining a virtual space, within which the movement activity of the mobile robotic device 11 is limited, as shown in FIGS. 7.

As indicated above, the present invention is operated by that the mobile robotic device 11 emits a signal toward a predetermined direction, and then the virtual wall generator 21 receives the signal to emit a sonic signal to enable the mobile robotic device 11 to steer. The difference between the present invention and the prior art lies in that the virtual wall generator 21 emits the sonic signal after receiving the signal as required not keeps emitting the signal. Therefore, the present invention is more power saving than the prior art.

What is claimed is:

1. A virtual wall system comprising:
A mobile robotic device having a steering unit for steering toward at least one direction, a steering control unit connected with said steering unit for controlling the steering of said steering unit, a signal transmitter mounted thereon for emitting a signal, and a sonic receiver for receiving a sonic signal; and
at least one virtual wall generator mounted on a planar surface that said mobile robotic device moves, said virtual wall generator having a signal receiver for receiving the signal emitted by said signal transmitter, a sonic transmitter for emitting a sonic signal toward a predetermined direction, and a signal controller for identifying the signal received by said signal receiver and controlling the emission of said sonic transmitter;
whereby said signal controller controls said sonic transmitter to emit the sonic signal while said signal receiver receives the signal and said mobile robotic device is moving, and then said sonic receiver receives the sonic signal and said control unit controls said steering unit to steer.

2. The virtual wall system as defined in claim 1, wherein said virtual wall generator has at least one cavity, said cavity being taper-shaped to be defined between two sloped sidewalls and a bottom sidewall and having an opening facing sideward, a distance between said two sloped sidewalls of said cavity being increasing from said bottom sidewall to said opening; said signal receiver and said sonic transmitter are mounted in said cavity.

3. The virtual wall system as defined in claim 2, wherein said virtual wall generator includes two cavities located back to back.

4. The virtual wall system as defined in claim 2, wherein said virtual wall generator includes two cavities located at the right angle.

5. The virtual wall system as defined in claim 1, wherein said virtual wall generator includes a power module for supplying electricity.

6. The virtual wall system as defined in claim 5, wherein said power module is a battery.

7. The virtual wall system as defined in claim 1, wherein the signal emitted by said signal transmitter is a light signal.

8. The virtual wall system as defined in claim 1, wherein said sonic signal emitted by said sonic transmitter is an ultrasonic signal.

9. The virtual wall system as defined in claim 1, wherein said signal transmitter is mounted on a side of said mobile robotic device.
